(19) United States
(12) Patent Application Publication
(10) Pub. No.: US 2020/0398269 A1
(43) Pub. Date: Dec. 24, 2020

(54) Sample support for the take-up of dried blood constituents and process for obtaining a membrane element with dried blood constituents

(71) Applicant: EUROIMMUN Medizinische Labordiagnostika AG, Luebeck (DE)

(72) Inventors: Alf Weimann, Luebeck (DE); Lisa Honold, Gaeufelden (DE); Henning Seismann, Nienwohld (DE); Winfried Stoecker, Gross Groenau (DE)

(73) Assignee: EUROIMMUN Medizinische Labordiagnostika AG, Luebeck (DE)

(21) Appl. No.: 16/946,200

(22) Filed: Jun. 10, 2020

(30) Foreign Application Priority Data
Jun. 19, 2019 (EP) 19181249.4

(51) Int. Cl. B01L 3/00

(52) U.S. Cl. CPC B01L 3/508; B01L 2300/12; B01L 2300/0672; B01L 2300/044; B01L 2300/069

(57) ABSTRACT

A sample support has an absorbent membrane layer which is based on a nonwoven polyolefin and which has at least one take-up region with dried blood constituents. It moreover has a film layer based on a plastic, where the film layer has received antistatic pretreatment. The membrane layer and the film layer have been connected to one another mechanically in one subregion of the sample support. but the layers have moreover not been connected to one another mechanically in the take-up region. It is preferable that, when the sample support is placed onto a uniformly level surface the membrane layer covers the film layer at least in the take-up region.

### CROSS-REFERENCE TO RELATED APPLICATION

The present application claims the benefit to European application EP 19181249.4, filed on Jun. 19, 2019, the content of which is hereby incorporated by reference in its entirety.

### BACKGROUND OF THE INVENTION

### Field of the Invention

The invention relates to a sample support. The sample support has an absorbent membrane layer which is based on a nonwoven polyolefin and which has at least one take-up region with dried blood constituents. It moreover has a film layer based on a plastic, where the film layer has received antistatic pretreatment. The membrane layer and the film layer have been connected to one another mechanically in one subregion of the sample support, but the layers have moreover not been connected to one another mechanically in the take-up region. It is preferable that, when the sample support is placed onto a uniformly level surface the membrane layer covers the film layer at least in the take-up region.

The invention further relates to a process for obtaining a membrane element with dried blood constituents. A sample support is provided from the process, and is placed onto a placement region. A vessel is provided below the placement region. A punching device is used to punch the membrane element out from the take-up region of the sample support in a manner that causes the punched-out membrane element and a film element punched out from the film layer to fall into the vessel.

### Discussion of the Background

Many qualitative determinations in the analytical sector and specifically in laboratory diagnostics are directed solely at correct determination of the presence or absence of an analyte, rather than determining the concentration of which it is present in the blood of a patient. By way of example, that is the case when the blood sample is being investigated in order to find whether the patient has a metabolic disease associated with a defective gene. The sole requirement is then study of the blood sample to determine the presence of such a gene, rather than to determine how much of the genetic material comprising the gene is present in the sample.

In the case of other analytes it is necessary to determine the concentration of the analyte in the blood because there is a known diagnostic reference concentration region. If the concentration of the analyte is within this region, it is likely that the patient is healthy. Such semi-quantitative or else strictly quantitative, determinations are therefore directed at correct determination of the quantity or concentration of the analyte.

Concentrations of particular analytes in the blood of patients are mostly measured by taking venous blood from the patient and then treating the blood to obtain serum. Irrespective of the fact that this invasive procedure is unpleasant for the patient, and on infrequent occasions even carries the risk of adverse effects on health such as nausea or fainting, blood sampling can be carried out only by trained technical staff, for example a doctor, or at least a nurse or an experienced laboratory technician. This requires that the patient attends a medical practice or a hospital.

In contrast, a much simpler and less invasive procedure is required to obtain capillary blood. When a sharp object is used to prick the fingertip or the ear lobe of the patient, a few capillary blood droplets appear, and these are taken up by a pipette and applied to an absorbent sample support. As soon as the blood has dried on the support, complete drying being achievable within a few hours in appropriate cases at room temperature, no further operations are required before transport of the support, which can indeed be achieved very easily by using letter-mailing services. The visit to the medical practice is thus rendered superfluous. Because the blood sample has dried, or the blood constituent has dried, the sample support with the sample located thereon is no longer classified as hazardous. From a support with dried blood, preferably capillary blood, it is possible to separate a section of support with blood. This can be achieved by way of example a device such as that described in U.S. Ser. No. 14/900,360, or by punching. The separated section of support with dried blood is often termed “dried blood spot” or “DBS”.

A support of the type mentioned here can by way of example be provided via a membrane layer which can take up the blood or blood constituents in a liquid physical state and specifically on which the blood or blood constituents then dry/dries before the support, in the form of the absorbent membrane, is transported.

The blood constituent taken up by the membrane can be whole blood, in particular capillary blood. Alternatively it is blood serum or blood plasma.

When a membrane element or a section of the support is punched out from the membrane in the abovementioned manner, there is the possibility here that the punching procedure cannot be carried out successfully.

In the usual procedure, the sample support in the form of a membrane is placed on a placement device or a placement region, and then the membrane is subjected to mechanical action from above by means of a punching device or a punching cutter in a manner that cuts a membrane element out from the membrane; it is desirable here that gravity causes the membrane element to fall into a vessel positioned underneath the sample support or underneath the membrane. This vessel can then be used subsequently for biochemical analysis.

Because of the membrane or the membrane layer has a certain mechanical flexibility, it is possible that during the punching procedure the membrane layer yields to the punching cutter to a certain extent in a manner such that no clean cut is actually obtained for the cutting-out of the membrane element, instead tearing of the membrane material occurs in the edge region of the membrane element or of a cut edge. A possible result of this is that the tearing process exerts additional forces on the membrane element, and that the membrane element therefore does not fall vertically but instead is deflected in its direction of fall. Static charging and deflection of the membrane element by electrostatic forces is reduced and, in appropriate cases avoided, by the antistatic film. It is possible here that the membrane element does not fall into the desired vessel provided.

If the membrane layer is too thick or has excessive thickness dimensions, it is possible that the punching cutter does not achieve complete and successful penetration of this membrane layer. and therefore that the membrane element is not completely cut out from the membrane layer. Here again, the membrane elements specifically fails to fall into the vessel provided.

When the blood constituent is applied in a liquid physical state to the take-up region of the membrane layer, it can be desirable that, in order to exclude any influence on distribution of the liquid blood constituent in the membrane layer or on migration of the said constituent out of the membrane layer, the upper side and the underside of this membrane layer are not in direct contact with other layers. For this purpose, it is advantageous that the membrane layer and the film layer have specifically not been connected to one another mechanically in the take-up region; it is thus possible, for a period required for the procedure of drying of the blood constituent, in the take-up region, to deflect the film layer away from the membrane layer.

However, the fact that in a subregion, preferably an edge region, of the sample support the film layer has been connected mechanically to the membrane layer also ensures easy subsequent provision of the film layer for the punching procedure. A user then merely has to deflect the film layer away from the membrane layer for the period required for the procedure of drying.

In relation to the sample support, the membrane layer can also be termed the upper side or upper layer of the sample support, and the film layer can also be termed the underside or the underlayer of the sample support.

### SUMMARY OF THE INVENTION

It is an object of the present invention to provide a sample support which during conduct of a punching process known from the related art permits successful punching-out of a membrane element which comprises a dried blood constituent in a manner such that the punched-out membrane element falls into a vessel that is provided and in particular located below the membrane layer.

This object is achieved via a sample support of the invention. This has an absorbent membrane layer which is based on a nonwoven polyolefin and which has at least one take-up region with dried blood constituents. It moreover has a film layer based on a plastic, where the film layer has received antistatic pre-treatment. The membrane layer and the film layer have been connected to one another mechanically in a subregion of the sample support, but the layers have moreover not been connected to one another mechanically in the take-up region. It is preferable that when the sample support is placed onto a uniformly level surface the membrane layer covers the film layer at least in the take-up region.

The present application includes the following embodiments:
1. Sample support (P, P2) having
   an absorbent membrane layer (M) which is based on a nonwoven polyolefin and which has at least one take-up region (A) with dried blood constituents (B),
   and also moreover a film layer (F) based on a plastic, where the film layer has received antistatic pretreatment,
   wherein the membrane layer (M) and the film layer (F) are connected to one another mechanically in a subregion (T) of the sample support,
   wherein furthermore the membrane layer and the film layer are connected to one another mechanically in the take-up region (A)
   and wherein, when the sample support (P, P2) is placed onto a uniformly horizontal surface (E) the membrane layer (M) covers the film layer (F) at least in the take-up region (A).
2. Sample support according to embodiment 1,
   wherein the plastic is a polyester.
3. Sample support according to embodiment 2,
   wherein the polyester is polyethylene terephthalate (PET).
4. Sample support according to any of the preceding embodiments,
   wherein the film layer (F) has received antistatic pretreatment such that the film layer has an antistatic agent at least in a subregion of its surface.
5. Sample support according to any of the preceding embodiments,
   wherein the polyolefin is selected from a group comprising polyethylene, polypropylene, polymethylpentene, polyisobutylene and polybutylene.
6. Sample support according to embodiment 5,
   wherein the polyolefin is polypropylene.
7. Sample support according to any of the preceding embodiments,
   wherein the sample support (P2) comprises at least one adjustable erection element (AE) which can be adjusted between a first configuration and a second configuration,
   wherein in the first configuration, when the sample support (P2) is placed onto the uniformly level surface, the erection element (AE) permits distancing of the membrane layer from the film layer
   and wherein in the second configuration, when the sample support (P2) is placed onto a uniformly level surface (E), the membrane layer (M) covers the film layer (F) at least in the take-up region (A).
8. Process for obtaining a membrane element with dried blood constituents comprising
   Provision of a sample support (P, P2) according to any of embodiments 1 to 7,
   Placement of the sample support (P, P2) onto a placement region (AB),
   Provision of a vessel (G) below the placement region (AB),
   Punching-out of the membrane element (ME) from the take-up region (A) of the sample support by means of a punching device (ST), in a manner that causes the punched-out membrane element (ME) and a film element (FE) punched out from the film layer (F) to fall into the vessel (G).
9. Process according to embodiment 8, moreover comprising
   Bringing the membrane element (ME) in the vessel (G) into contact with a liquid (FL) that is suitable for take-up of the analyte from the dried blood constituent and
   Detection of the analyte in the liquid.
10. Use of a sample support according to any of embodiments 1 to 7
   for the qualitative determination of presence of an analyte in the dried blood constituent,
   for the semi-quantitative determination of a concentration of an analyte in the dried blood constituent,
   or for the quantitative determination of a concentration of an analyte in the dried blood constituent.

### BRIEF DESCRIPTION OF DRAWINGS

FIG. 1 shows a plan view of a preferred embodiment of the sample support of the invention,

FIG. 2 shows a side view of the preferred embodiment of the sample support of the invention,

FIG. 3 shows a further embodiment of the sample support of the invention,

FIGS. 4a and 4b show the further embodiment of the sample support of the invention in different configurations,

FIG. 5 shows a first arrangement during a punching procedure for the punching-out of a membrane element,

FIG. 6 shows a second arrangement during a punching procedure for the punching-out of a membrane element,

FIG. 7 shows a sample support having a membrane layer and a film layer,

FIG. 8 shows a sample support having a membrane layer and a film layer,

FIG. 9 shows a first presentation of experimental results in terms of percentages,

FIG. 10 shows a presentation of experimental results with absolute values and percentages.

### DETAILED DESCRIPTION OF THE INVENTION

An advantage of the sample support of the invention is that, during the punching procedure, mechanical stabilization of the membrane layer becomes possible by virtue of the film layer provided in addition to the membrane layer, thus reducing the extent to which the membrane layer yields during the punching or cutting procedure. A possible result of this in appropriate cases is to prevent fraying of the membrane material in the region of the punched edge or cut edge, thus permitting achievement of greater precision in cutting-out of the membrane element from the membrane layer. Avoidance of fraying effects in the region of the cut edge or punched edge eliminates the possibility that the punched-out membrane is deflected into an incorrect correction and in certain cases does not fall into a vessel positioned below the punching device.

Another outcome achieved because the membrane layer and the film layer have not been connected to one another mechanically in the punched-out take-up region is that after the punched-out membrane element has fallen into the vessel that is to be provided its entire surface, i.e. its reverse side, or the side facing towards the film layer, can come into contact with reagents or biochemical liquids in the vessel, thus preventing distortion of expected results.

However, the fact that the film layer has been connected to the membrane layer mechanically in a subregion of the sample support, preferably an edge region of the sample support, provides easy handling for the user. The user must therefore merely grip the sample support at a particular location, for example at the abovementioned subregion or edge region, and can then, in a single operation, position both the film layer and the membrane layer together on a placement region of the punching device in a manner that arranges or orients membrane layer and film layer in a desired manner in relation to one another. There is therefore no requirement that the user first places a separate film layer and then places the membrane layer onto the film layer. The sample support can be used for the take-up of blood constituents in a liquid physical state in a laboratory or a medical practice, or else at a patient's dwelling, and then, after drying of the blood constituents, can be dispatched, or can be taken to a laboratory workstation, with no requirement for subsequent provision there of a separate film layer.

Because the film layer has received antistatic pretreatment, no electrostatic charging or electrostatic forces arise(s) during the punching procedure. Because the membrane layer and the film layer are mutually superposed, during the punching procedure the punching cutter cuts through both the membrane layer and the film layer. This punching cutter is usually made of metal. Friction of metal on a plastic during the punching procedure can cause electrostatic charging of the film and, in certain cases, also of the membrane element, and electrostatic forces can thus act on the punched-out film element and, in certain cases, also on the membrane element. A possible result of this is that the punched-out film element and, in certain cases, also the membrane element, suffers deflection of its direction of fall and does not fall into the positioned vessel. If, by way of example. the punched-out film element were to fall into another vessel alongside the desired vessel, a possible result during conduct of a plurality of punching-out procedures by plurality of take-up regions of a sample support would be cross-contamination between different blood constituents and, respectively, different blood samples in the respective vessels. Antistatic pretreatment of the film layer ensures that electrostatic forces cannot cause undesired incorrect deflection of the punched-out membrane element and/or of the punched-out film element.

It is preferable that the film layer has received antistatic pretreatment on both sides.

For the purposes of this application, the expression “quantitative determination” means a determination which can provide a conclusion concerning the absolute concentration of the analyte, more preferably with use of a numeric value. An alternative possibility here is a relative concentration determination, or a semi-quantitative determination which permits allocation of the concentration of a range from at least three, if at all possible at least four, concentration ranges, e.g. negative, weakly positive and positive. In particular, the concentration is determined with the aid of calibrators, where these preferably involve two or more, preferably four, units, preferably solutions or solid analytes coated on a diagnostically useful support, which respectively comprise a known quantity of the analyte, where the two or more units respectively comprise a different known quantity.

A quantitative determination is preferably implemented with use of a method selected from the group comprising immunodiffusion, immunoelectrophoresis, light scattering, agglutination and immunoassay with labelling—for example from the group comprising immunoassay with radioactive labelling, with enzymatic labelling, more preferably ELISA, with chemiluminescence labelling, more preferably electrochemiluminescence labelling, and with immunofluorescence labelling, more preferably indirect immunofluorescence labelling—preferably with ELISA.

The dried blood constituent is eluted from the punched-out membrane element via contact of the punched-out membrane element with a liquid that is suitable for take-up of the analyte from the dried blood constituent. It is possible here in particular to use aqueous buffers with suitable pH and salt content, for example PBS. The precise composition of the liquid and the conditions and the duration of contact depend on the nature of the analyte and can be established via routine experiments relating to stabilization and optimization, the aim here being take-up of the analyte into the liquid is as complete as possible. At the same time, the liquid is also selected to be, as far as possible, compatible with the method subsequently used for the detection of the analyte. The presence or absence of the relevant analyte in the liquid is then detected. This procedure determines whether the analyte is present or absent, or is present at a concentration above the detection limit of the detection method used. Preference is given to semi-quantitative or quantitative determination of the analyte. Various options for the conduct of the method are described in the related art, examples being Grüner, N., Stambouli, O. and Ross, R. S. (2015) Dried Blood Spots—Preparing and Processing for Use in Immunoassays and in Molecular Techniques, J. Vis. Exp 97, 52619.

Advantageous embodiments of the invention are provided by the dependent claims and are explained in more detail in the description below, in some cases with reference to the figures.

The plastic is preferably a polyester.

The polyester is preferably polyethylene terephthalate.

It is preferable that the film layer has received antistatic pretreatment such that the film layer has an antistatic agent at least in a subregion of its surface. It is preferable that the film layer has an antistatic agent on both sides, respectively in at least one subregion.

It is preferable that the polyolefin is selected from the group comprising polyethylene, polypropylene, polymethylpentene, polyisobutylene and polybutylene.

It is preferable that the polyolefin is polypropylene.

It is preferable that the sample support comprises at least one adjustable deployable element which can be adjusted between a first configuration and a second configuration. In the first configuration, when the sample support is placed onto a uniformly level surface, the deployable element permits distancing of the membrane layer from the film layer. In the second configuration, when the sample support is placed onto the uniformly level surface, the membrane layer covers the film layer at least in the take-up region.

If the blood constituent is applied in a liquid physical state to the take-up region of the sample support, in the first configuration this deployable element can bring about distancing of the film layer from the membrane layer, so that for a time required by a drying procedure the blood constituent does not pass out of the membrane layer, or out of the take-up region of the membrane layer, onto the film layer, and is not conducted there away from the take-up region or away from the membrane layer. The residence time of the initially liquid blood constituent in the take-up region or in the membrane layer is thus maximized for the time required for the drying procedure. In other words, the blood constituent does not pass onto the film layer, and therefore the maximal possible quantity of liquid blood constituent therefore remains in the membrane layer during the drying procedure. This is in particular advantageous because the blood constituent, being a sample obtained from a patient, can often be provided only in a restricted quantity or with a restricted volume, therefore being a valuable resources.

In the second configuration of the deployable element, the membrane layer covers the film layer in the take-up region, and in the second configuration the sample support can then therefore be introduced into a punching procedure in the manner described.

A process is moreover described for obtaining a membrane element with dried blood constituent. In a first step, a sample support of the invention is provided. This sample support is placed onto a placement region. A vessel is placed below the placement region. A membrane element from the take-up region of the sample support is then punched out by means of a punching device or by means of a punching cutter in a manner that causes the punched-out membrane element, and a film element punched out from the film layer, to fall into the vessel.

The process preferably moreover comprises the following steps:
Bringing the membrane element in the vessel into contact with a liquid that is suitable for take-up of the analyte from the dried blood constituent and
Detection of the analyte in the liquid.

A use of a sample support of the invention is moreover proposed. Its aim can be the qualitative determination of presence of an analyte in the dried blood constituent. The use can alternatively be aimed at the semi-quantitative determination of a concentration of an analyte in the dried blood constituent. The use can preferably be aimed at the quantitative determination of a concentration of an analyte in the dried blood constituent.

The invention is explained in more detail below on the basis of specific embodiments, without restriction of the general concept of the invention, with reference to the figures:

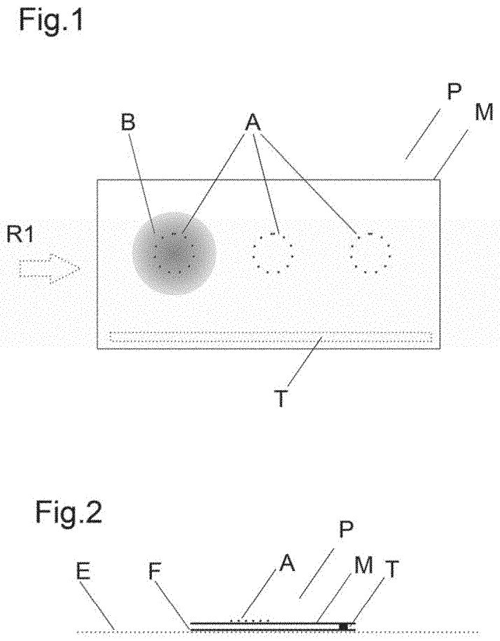

FIG. 1 shows a plan view of a preferred embodiment of the sample support of the invention,

FIG. 2 shows a side view of the preferred embodiment of the sample support of the invention,

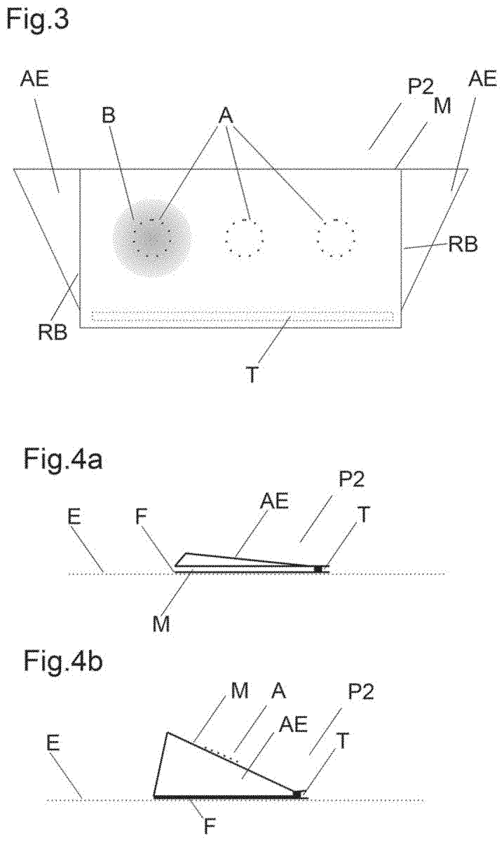

FIG. 3 shows a further embodiment of the sample support of the invention,

FIGS. 4a and 4b show the further embodiment of the sample support of the invention in different configurations,

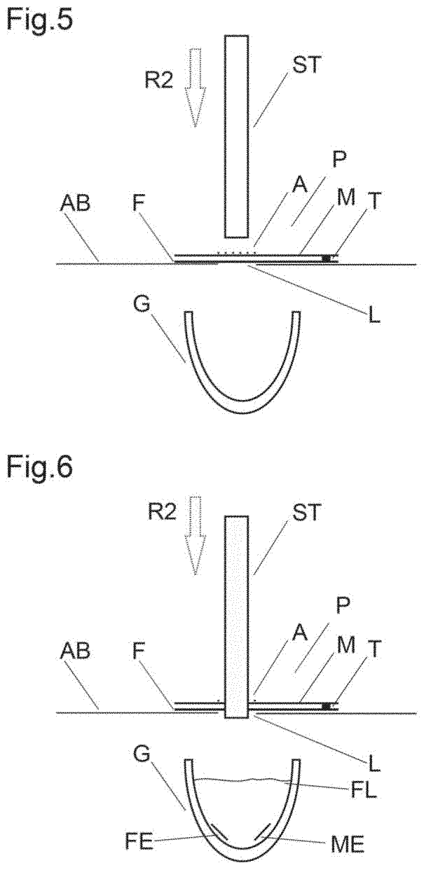

FIG. 5 shows a first arrangement during a punching procedure for the punching-out of a membrane element,

FIG. 6 shows a second arrangement during a punching procedure for the punching-out of a membrane element,

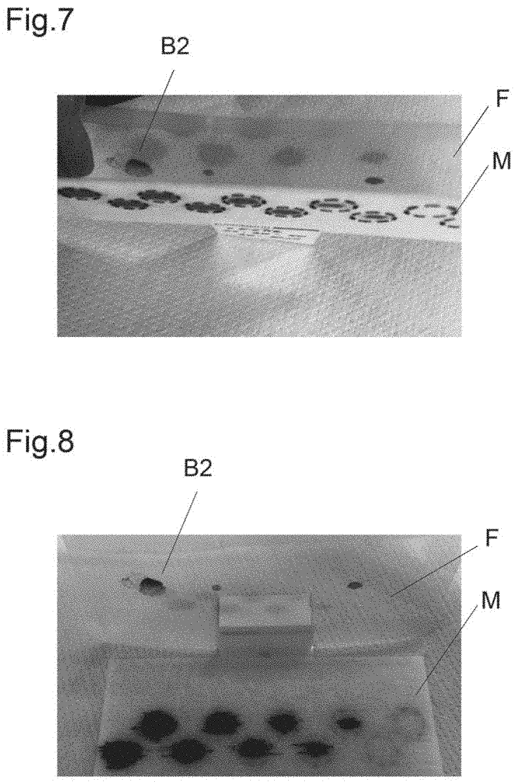

FIG. 7 and FIG. 8 show respective sample supports, each of which has a membrane layer and each of which has a film layer,

FIG. 9 shows a first presentation of experimental results in terms of percentages,

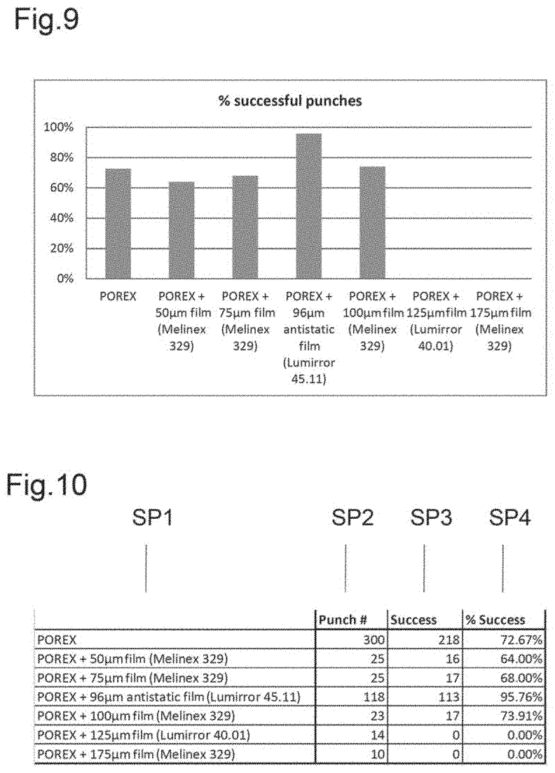

FIG. 10 shows a presentation of experimental results with absolute values and percentages.

FIG. 1 shows a sample support P with a membrane layer M. which is based on a relatively high-level polyolefin. The membrane layer M has at least one or more take-up regions A, where at least one of the take-up regions A comprises a dried blood constituent B. This blood constituent can be whole blood, in particular capillary blood, or blood plasma or blood serum.

A subregion T, preferably an edge region, is indicated by dashes.

FIG. 1 moreover shows an arrow R1, which indicates a side-view perspective from which the sample support P is depicted in FIG. 2.

FIG. 2 shows the sample support P with the membrane layer M and with a take-up region A. The blood constituents B from FIG. 1 are not explicitly included in this drawing.

Below the membrane layer M there is a film layer F.

The sample support P has been placed on a uniformly level surface E.

The film layer F is based on a plastic, and at least one side of the film layer F, preferably both the upper side and the underside of the film layer F, has/have received antistatic pretreatment.

In the subregion T, the membrane layer M and the film layer F have been connected to one another mechanically. This can by way of example have been achieved via adhesive strip in the subregion T.

In the take-up region A. the film layer F and the membrane layer M have not been connected to one another mechanically.

When the sample support P is placed onto the uniformly level surface E, the membrane layer M covers the film layer F at least in the take-up region A.

FIG. 5 shows the sample support P from FIG. 2 and FIG. 1 in the side view from FIG. 2 in the case where the sample support P has been placed onto a placement region AB. The placement region AB preferably has an aperture L.

A vessel G has been provided below the placement region AB.

A membrane element is punched out from the take-up region A of the membrane layer M of the sample support P by means of a punching device ST, the intention here being that the punched-out membrane element then falls, together with a film element punched out from the film layer F, into the vessel G. For this purpose, the punching device or the punching cutter ST is moved from above in a direction R2 running perpendicular to the placement region AB.

FIG. 6 shows another arrangement in which the punching cutter or the punching device ST has punched out a membrane element ME and also a film element FE from the sample support P. Punching is considered to be successful if both the membrane element ME and the film element FE fall into the vessel.

The membrane element ME in the vessel G can then preferably be brought into contact with a biochemical liquid or a liquid reagent FL, in order to determine presence of an analyte or else to carry out a semi-quantitative, or alternatively a quantitative, determination of a concentration of an analyte in the dried blood constituent.

FIG. 9 shows percentage evaluation results of punching tests in which a Panthera Puncher 9 from PerkinElmer was used as punching device. The membrane layer of the sample support is based on a nonwoven polyolefin. and in this case is a Porex BNW441435 membrane.

A punching procedure was then assessed as successful if both the membrane element and the film element fell into the vessel provided for this purpose. Wells of Eppendorf 30501306 deep-well polypropylene microsheets with 96 wells per microsheet were used as vessel. However, it is alternatively possible to use standard microsheets with smaller depth and made of other material, preferably polystyrene.

Errors could arise in the following ways:
punching-out of the membrane element was impossible because of excessive mechanical resistance exerted by an underlying film layer, or
although the membrane element and the film element were punched out, they fell alongside, rather than into, the vessel positioned directly underneath, or
although the punched-out membrane element was received in the vessel provided, the punched-out film element did not pass into the vessel, but instead passed into an adjacently positioned microplate vessel: this can bring about cross-contamination between the samples.

FIG. 10 shows the absolute values associated with the percentage evaluation results from FIG. 9. The first column SP1 lists the respective configurations of membrane layer (POREX) and associated film layers. The respective entries in column 1 here also contain the precise product designations of the corresponding film layers with their respective thicknesses in micrometers. It should be emphasized that only the Lumirror 45.11 film is an antistatically coated film.

The column SP2 lists the number of punching tests carried out. The column SP3 lists the absolute number of successful punching tests. The column SP4 lists the respective percentage proportions of successful punching tests.

When no film of any kind, or no film layer, was used, the punching success rate, using only a POREX membrane, with membrane layer without film layer, was 72.67%.

When various films which had not received antistatic pretreatment were used, the proportion of successful punching tests is below 75%. In the embodiment having a film layer of thickness 125 μm or 175 μm no punching tests at all were successful, because the mechanical properties of these films did not permit successful punching, and punching-out of membrane elements was completely impossible.

When Lumirror 45.11 film, thickness % μm, which had received antistatic pretreatment, was used the success rate of punching tests was significantly increased, the proportion of successful tests being 95.76%.

It is clear that antistatic pretreatment of the film layer achieves significantly improved results.

The Lumirror 45.11 film layer used here has received antistatic pretreatment and is a film layer based on polyester.

FIG. 3 shows another preferred embodiment P2 of the sample support of the invention. In contrast to the first embodiment of the sample support P of the invention in FIG. 1, this embodiment P2 of the sample support moreover comprises one or more deployable elements AE. A deployable element AE is preferably a paperboard element or paper element secured at an edge region RB of the membrane layer M. The deployable element AE can be folded along the edge region or along an appropriate fold line, and thus oriented. FIG. 3 shows the sample support P2 in what is known as a second configuration, in which it has been placed onto a uniformly level surface in a manner such that the membrane layer M covers the film layer F in the take-up region A.

FIG. 4a shows the sample support P2 in this “second configuration”, where the deployable elements AE in this side view have been slightly bent upwards, so that the membrane layer M covers the film layer F in the take-up region A which is indicated in FIG. 2 but which is not directly visible here.

FIG. 4b shows the sample support P2 in a first configuration in which the deployable element AE has been angle-folded downwards from the configuration in FIG. 3 in a manner that permits deployment of a type that results in distancing of the membrane layer M from the film layer F when the sample support P2 has also been placed on the uniformly level surface E.

This permits, after application of a particular blood constituent to the take-up region A of the membrane layer M, drying of this blood constituent into the membrane layer M, with no contact between the film layer F and an underside of the membrane layer M. It is thus not possible that portions of a blood constituent leave the membrane layer M and dry onto a surface of the film layer F.

The deployable elements AE are therefore preferably foldable elements at the sides of the sample support P2; the sample support P2 is therefore supported by the foldable elements AE in a manner that, in the first configuration, distances the membrane layer M from the film layer in the region of the take-up region A.

When the sample support P2 is placed onto the uniformly level surface E in the first configuration, the deployable element(s) AE bring(s) about distancing of the film layer F from the membrane layer M in a manner that causes the film layer F to lie on the uniformly level surface E.

FIGS. 7 and 8 here show respective membrane layers M and film layers F in which, because of contact between the film layer F and the membrane layer M during the drying procedure, partial quantities B2 of blood constituents have dried onto a respective surface of the respective film layers F. This is specifically to be avoided, and is avoided via the embodiment of the sample support P2 in the FIGS. 3, 4a and 4b.

1. A sample support, comprising:
an absorbent membrane layer, which is based on a nonwoven polyolefin and which has at least one take-up region with dried blood constituents, and
a film layer based on a plastic, wherein the film layer has received antistatic pretreatment,
wherein the absorbent membrane layer and the film layer are connected to one another mechanically in a subregion of the sample support,
wherein the absorbent membrane layer and the film layer are connected to one another mechanically in the at least one take-up region, and
wherein, when the sample support is placed onto a uniformly horizontal surface, the absorbent membrane layer covers the film layer at least in the at least one take-up region (A).

2. The sample support according to claim 1, wherein the plastic is a polyester.

3. The sample support according to claim 2, wherein the polyester is polyethylene terephthalate (PET).

4. The sample support according to claim 1, wherein the film layer has received antistatic pretreatment such that the film layer has an antistatic agent at least in a subregion of a surface of the film layer.

5. The sample support according to claim 1, wherein the nonwoven polyolefin is selected from the group consisting of polyethylene, polypropylene, polymethylpentene, polyisobutylene, and polybutylene.

6. The sample support according to claim 5, wherein the nonwoven polyolefin is polypropylene.

7. The sample support according to claim 1, wherein the sample support comprises:
at least one adjustable erection element which can be adjusted between a first configuration and a second configuration,
wherein in the first configuration, when the sample support is placed onto the uniformly horizontal surface, the at least one adjustable erection element permits distancing of the absorbent membrane layer from the film layer, and
wherein in the second configuration, when the sample support is placed onto the uniformly horizontal surface, the absorbent membrane layer covers the film layer at least in the at least one take-up region.

8. A process for obtaining a membrane element with dried blood constituents, the process comprising:
placing the sample support according to claim 1 onto a placement region,
providing a vessel below the placement region, and
punching-out the membrane element from the at least one take-up region of the sample support by a punching device, in a manner that causes a punched-out membrane element and a film element punched out from the film layer to fall into the vessel.

9. The process according to claim 8, further comprising:
bringing the punched-out membrane element in the vessel into contact with a liquid that is suitable for take-up of an analyte from the dried blood constituent, and detecting the analyte in the liquid.

10. A method, comprising:
determining the presence of an analyte in a dried blood constituent with the sample support according to claim 1,
wherein the determination is qualitative, semi-quantitative, or quantitative.
